(19) United States
(12) Patent Application Publication
(10) Pub. No.: US 2024/0415092 A1
(43) Pub. Date: Dec. 19, 2024

(54) DISPENSER ASSEMBLY

(71) Applicant: PLUTO OPCO (CAYMAN), LLC, Grand Cayman (KY)

(72) Inventors: Michael HARPER, Fort Worth, TX (US); Ryan PAXSON, Elk Rapids, MI (US); Melaney NORTHROP, Arlington, TX (US); Matthew KIDD, Fort Worth, TX (US)

(21) Appl. No.: 18/737,681

(22) Filed: Jun. 7, 2024

Related U.S. Application Data
(60) Provisional application No. 63/521,080, filed on Jun. 14, 2023.

(51) Int. Cl. A01K 5/01; A01K 5/02

(52) U.S. Cl. CPC A01K 5/0114; A01K 5/0275

(57) ABSTRACT

A dispenser assembly having a base member and a receptacle. The base member has a bowl. The receptacle has a dispensing opening defined at the first end thereof. The receptacle is configured to fit on to the base member such that the dispensing opening is positioned to dispense contents of the receptacle into the bowl of the base member in an in-use orientation. The receptacle is dimensioned and shaped to at least partially fit into the bowl in a stowed orientation such that in the stowed orientation the receptacle and base member occupy a volume that is less than a volume corresponding to the in-use orientation.

### CROSS-REFERENCE TO RELATED APPLICATION

This U.S. utility application claims priority under 35 U.S.C. § 119(e) to U.S. Provisional Patent Application No. 63/521,080, filed on Jun. 14, 2023, the entire contents of which are hereby incorporated herein by reference.

### BACKGROUND

### Technical Field

The present disclosure generally relates to a dispenser assembly for providing food or water for a pet. More specifically, the present disclosure relates to a dispenser assembly with a base and a receptacle for food or water that can be arranged for shipping with at least a portion of the receptacle being stored within the base and arranged for use with one end of the receptacle being placed on the base for dispensing water or food into the base.

### Background Information

Dispensers for pet food and for providing water to pets typically include a bottle or receptacle that is filled with water or pet food and attached to or positioned on a base that includes a bowl for food or water. Typically, when the bottle and base are boxed for shipping, the bottle and base need significant volume within a shipping box that is much greater than the volume of the bottle and base when in an in-use orientation.

### SUMMARY

One object of the present disclosure is to provide a dispenser assembly with a base and a bottle or receptacle dimensioned and shaped to at least partially fit into the base for shipping or storage.

In view of the state of the known technology, one aspect of the present disclosure is to provide a dispenser assembly with a base member and a receptacle. The base member has a bowl. The receptacle has a dispensing opening defined at the first end thereof. The receptacle is configured to fit on to the base member such that the dispensing opening is positioned to dispense contents of the receptacle into the bowl of the base member in an in-use orientation. The receptacle is dimensioned and shaped to at least partially fit into the bowl in a stowed orientation such that in the stowed orientation the receptacle and base member occupy a volume that is less than a volume corresponding to the in-use orientation.

### BRIEF DESCRIPTION OF THE DRAWINGS

Referring now to the attached drawings which form a part of this original disclosure:

FIG. 1 is a perspective view of a dispenser assembly that includes a base member and a receptacle with the receptacle at least partially inserted into the base in a stowed orientation for shipping or storage in accordance with a first embodiment;

FIG. 2 is another perspective view of the dispenser assembly showing the receptacle installed on to a portion of the base in an in-use orientation for dispensing water or other liquid into a bowl of the base member in accordance with the first embodiment;

FIG. 3 is a side view of the dispenser assembly with the receptacle and the base member in the in-use orientation and inserted into a first box for shipping such that the dispenser assembly requires a first volume corresponding to the volume of the first box in accordance with the first embodiment;

FIG. 4 is another side view of the dispenser assembly with the receptacle and the base member in the stowed orientation and inserted into a second box for shipping such that the dispenser assembly requires a second volume corresponding to the volume of the second box, the first volume of the first box being larger than the second volume of the second box in accordance with the first embodiment;

FIG. 5 is a perspective view of three dispenser assemblies in the stowed orientation arranged in a side-by-side line demonstrating the minimal volume required to store a plurality of dispenser assemblies in accordance with the first embodiment;

FIG. 6 is a side view of two dispenser assemblies in the stowed orientation stacked on top of one another again demonstrating the minimal volume required to store a plurality of dispenser assemblies in accordance with the first embodiment;

FIG. 7 is an exploded view of the dispenser assembly showing the base member having a bowl and a receiving area and the receptacle having a lid with a valve therein separated from the receptacle in accordance with the first embodiment;

FIG. 8 is an exploded view of the dispenser assembly showing the base member and the receptacle with the lid attached to the bottom of the receptacle in accordance with the first embodiment;

FIG. 9 is a perspective view of the dispenser assembly in the in-use orientation in accordance with the first embodiment;

FIG. 10 is a perspective view of the receptacle removed from the base member in accordance with the first embodiment;

FIG. 11 is a side view of the dispenser assembly showing the lid at least partially extending into the bowl and receiving area of the base member in the stowed orientation in accordance with the first embodiment;

FIG. 12 is a side cross-sectional view of the dispenser assembly in the in-use orientation showing a valve in the lid of the receptacle in an open position allowing water or liquid from within the receptacle to flow into the receiving area of the base member and into the bowl in accordance with the first embodiment;

FIG. 13 is a perspective view of a dispenser assembly that includes a base member and a receptacle with the receptacle at least partially inserted into the base in a stowed orientation for shipping or storage in accordance with a second embodiment;

FIG. 14 is another perspective view of the dispenser assembly showing the receptacle installed on to a portion of the base in an in-use orientation for dispensing dry food or semi-solid food into a bowl of the base member in accordance with the second embodiment;

FIG. 15 is a perspective view of the receptacle removed from the base member showing an open top and a curved bottom surface defining a chute for dispensing dry food or semi-solid food in accordance with the second embodiment;

FIG. 16 is a side view of the dispenser assembly in the stowed orientation in accordance with the second embodiment;

FIG. 17 is a side cross-sectional view of the dispenser assembly in the in-use orientation showing the curve surface (chute) at the bottom of the receptacle in accordance with the second embodiment;

FIG. 18 is a perspective view of a dispenser assembly having a base member and a receptacle in a stowed orientation with at least a portion of the receptacle being inserted into a bowl of the base member with a marketing label wrapped around the receptacle and base member holding them together in accordance with a third embodiment;

FIG. 19 is a perspective view of the dispenser assembly with the base member and the receptacle in an in-use orientation with the receptacle being set on top of a portion of the base member with a chute of the receptacle located with the bowl of the base member in accordance with the third embodiment;

FIG. 20 is a cross-sectional view of the dispenser assembly with the base member and the receptacle in the in-use orientation in accordance with the third embodiment;

FIG. 21 is a perspective view of a dispenser assembly having a base member, a retaining member and a receptacle in a stowed orientation with at least a portion of the receptacle being inserted into a bowl of the base member with a marketing label wrapped around the receptacle and base member holding them together in accordance with a fourth embodiment;

FIG. 22 is a perspective view of the dispenser assembly with the base member and the receptacle in an in-use orientation with the receptacle being set on top of the retaining member, the retaining member being set atop a portion of the base member in accordance with the fourth embodiment;

FIG. 23 is an exploded view of the dispenser assembly with the base member and the receptacle in the in-use orientation in accordance with the fourth embodiment;

FIG. 24 is a perspective view of a dispenser assembly having a base member, a retaining member and a receptacle in a stowed orientation with at least a portion of the receptacle being inserted into a bowl of the base member with a marketing label wrapped around the receptacle and base member holding them together in accordance with a fifth embodiment;

FIG. 25 is a perspective view of the dispenser assembly with the base member, the retaining member and the receptacle in an in-use orientation with the receptacle being set on top of the retaining member, the retaining member being set atop a portion of the base member in accordance with the fifth embodiment;

FIG. 26 is a top view of the dispenser assembly with the base member and the receptacle in the in-use orientation in accordance with the fifth embodiment;

FIG. 27 is a perspective view of a dispenser assembly having a base member, a retaining member and a receptacle in a stowed orientation with at least a portion of the receptacle being inserted into a bowl of the base member with a marketing label wrapped around the receptacle and base member holding them together in accordance with a sixth embodiment;

FIG. 28 is a perspective view of the dispenser assembly with the base member, the retaining member and the receptacle in an in-use orientation with the receptacle being set on top of the retaining member, the retaining member being set atop a portion of the base member in accordance with the sixth embodiment;

FIG. 29 is an exploded view of the dispenser assembly with the base member, the retaining member and the receptacle in the in-use orientation in accordance with the sixth embodiment;

FIG. 30 is a perspective view of a dispenser assembly having a base member and a receptacle in a stowed orientation with at least a portion of the receptacle being inserted into a bowl of the base member with a marketing label wrapped around the receptacle and base member holding them together in accordance with a seventh embodiment;

FIG. 31 is a perspective view of the dispenser assembly with the base member and the receptacle in an in-use orientation with the receptacle being set on top of the retaining member, the retaining member being set atop a portion of the base member in accordance with the seventh embodiment;

FIG. 32 is a side view of the dispenser assembly with the base member, the retaining member and the receptacle in the stowed orientation in accordance with the seventh embodiment;

FIG. 33 is a perspective view of a dispenser assembly having a base member and a receptacle in a stowed orientation with at least a portion of the receptacle being inserted into a bowl of the base member with a marketing label wrapped around the receptacle and base member holding them together in accordance with an eighth embodiment;

FIG. 34 is an exploded view of the receptacle showing a lid and chute portion separated from the receptacle in the in-use orientation in accordance with the eighth embodiment;

FIG. 35 is a side view of the dispenser assembly with the base member and the receptacle in the stowed orientation in accordance with the eighth embodiment;

FIG. 36 is a perspective view of the dispenser assembly with the base member and the receptacle in the in-use orientation in accordance with the eighth embodiment;

FIG. 37 is a perspective view of a dispenser assembly having a base member and a receptacle in a stowed orientation with at least a portion of the receptacle being inserted into a bowl of the base member with a marketing label wrapped around the receptacle and base member holding them together in accordance with a ninth embodiment;

FIG. 38 is another perspective view of the dispenser assembly in the in-use orientation in accordance with the ninth embodiment;

FIG. 39 is a perspective view of the dispenser assembly shown in the stowed orientation with the marketing label removed to show details of the receptacle and base member in accordance with the ninth embodiment;

FIG. 40 is a perspective view of a dispenser assembly having a base member and a receptacle in a stowed orientation with at least a portion of the receptacle being inserted into a bowl of the base member with a marketing label wrapped around the receptacle and base member holding them together in accordance with a tenth embodiment;

FIG. 41 is a perspective view of the dispenser assembly with the base member and the receptacle in an in-use orientation in accordance with the tenth embodiment; and

FIG. 42 is a side cross-sectional view of the dispenser assembly with the base member and the receptacle in the in-use orientation showing a chute portion of the receptacle in accordance with the tenth embodiment.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

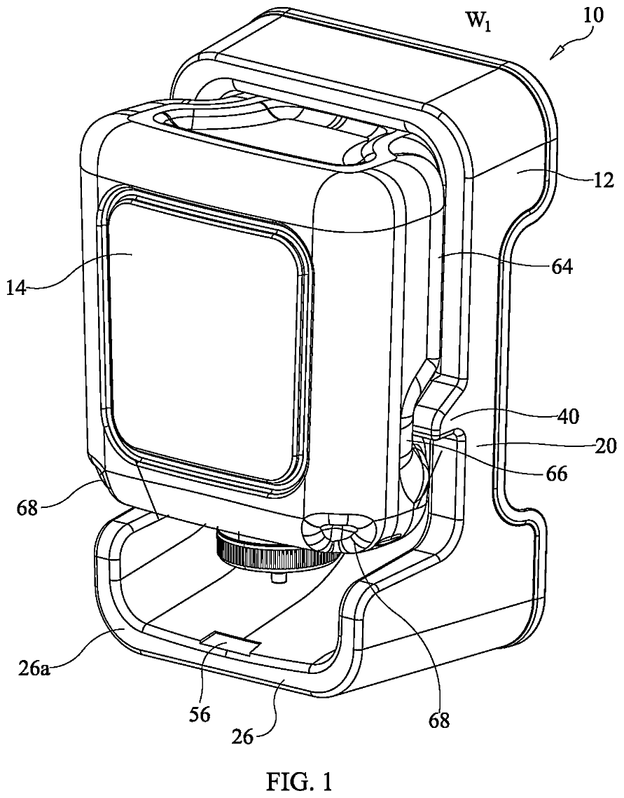

Referring initially to FIG. 1, a dispenser assembly 10 is illustrated in accordance with a first embodiment. In the depicted first embodiment, the dispenser assembly 10 is configured to dispense water or other liquid for consumption by a pet, such as a dog or cat.

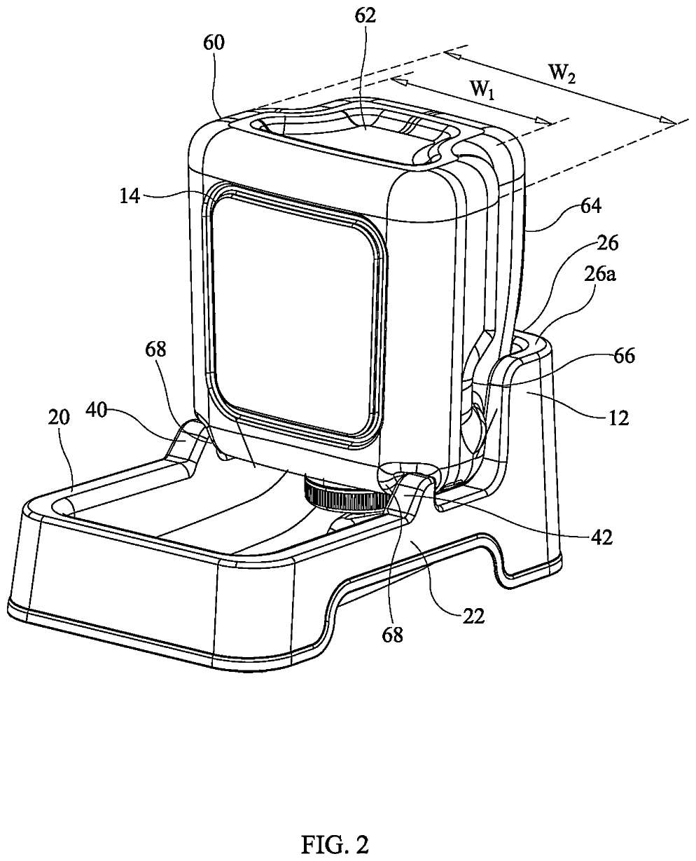

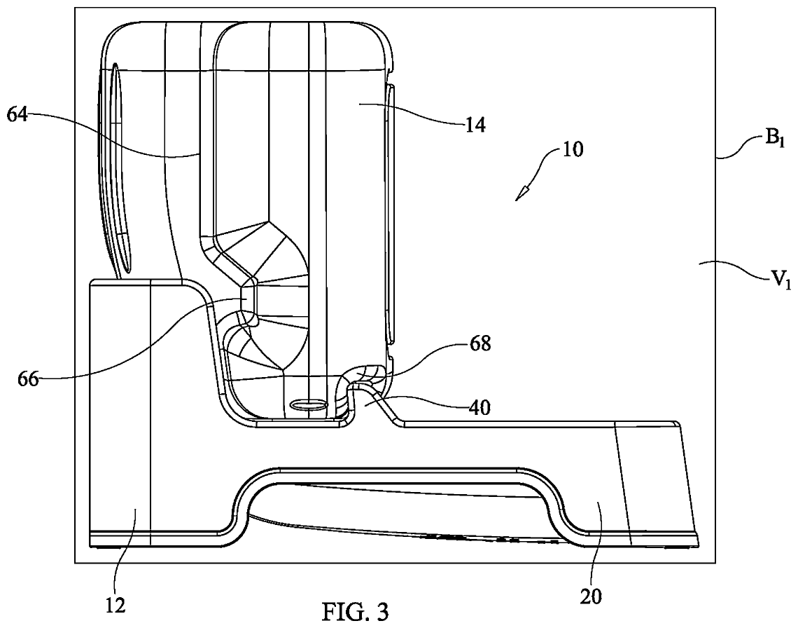

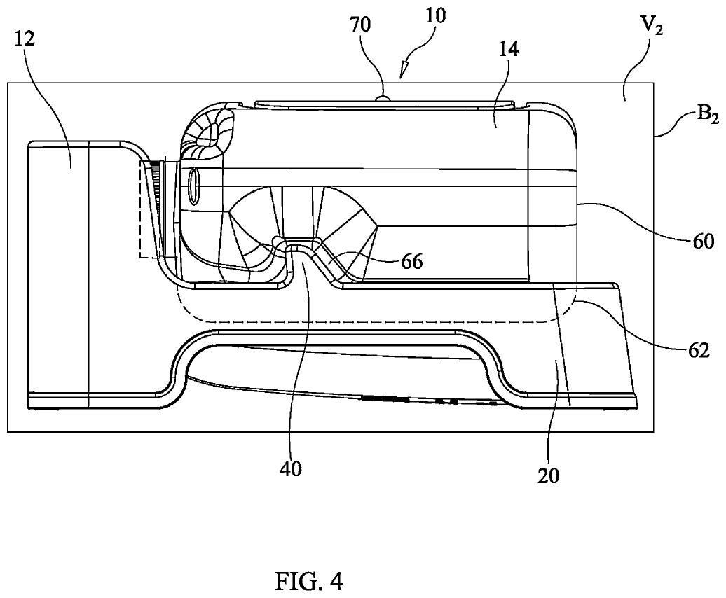

The dispenser assembly 10 includes a base 12 and a bottle or receptacle 14. FIGS. 1 and 4 show the dispenser assembly 10 in a stowed orientation with the receptacle 14 nestled against and partially within the base 12. FIGS. 2 and 3 show the dispenser assembly 10 in an in-use orientation with the base 12 in a horizontal position and the receptacle 14 extending perpendicular to the base 12, as is described in greater detail below.

The base 12 and the receptacle 14 are dimensioned and shaped such that with the dispenser assembly 10 in the in-use orientation, the dispenser assembly 10 can fit in a first box B₁ having a first volume V₁ for shipping, as shown in FIG. 3. A dispenser assembly without the features of the base 12 and the receptacle 14 described herein below, would require shipping the dispenser assembly in a box, such as the first box B₁, which is conventional rectangular shaped box. The features of the base 12 and the receptacle 14 described herein below make it possible to position the receptacle 14 in the stowed orientation where a portion of the receptacle 14 fits within the base 12, as described further below. With the dispenser assembly 10 in the stowed orientation, the dispenser assembly 10 can fit in a second box B₂ for shipping where the box B₂ is smaller than the box B₁, and where the box B₂ is a conventional rectangular box that is smaller than the box B₁. Specifically, the second box B₂ has a second volume V₂, as shown in FIG. 4. As can be easily discerned by comparing FIGS. 3 and 4, the box B₁ is larger than the box B₂. Correspondingly, the volume V₁ within the box B₁ is larger than the volume V₂ within the box B₂. Further, the second volume V₂ is preferably between 70 and 80% the size of the first volume V1. Clearly, for shipping purposes, with the dispenser assembly 10 in the stowed orientation, the dispenser assembly 10 takes less space, can be fitted into a smaller box B₂, as compared to the box B₁, thereby reducing shipping costs from the factory to points of sale and take up less overall space during shipping.

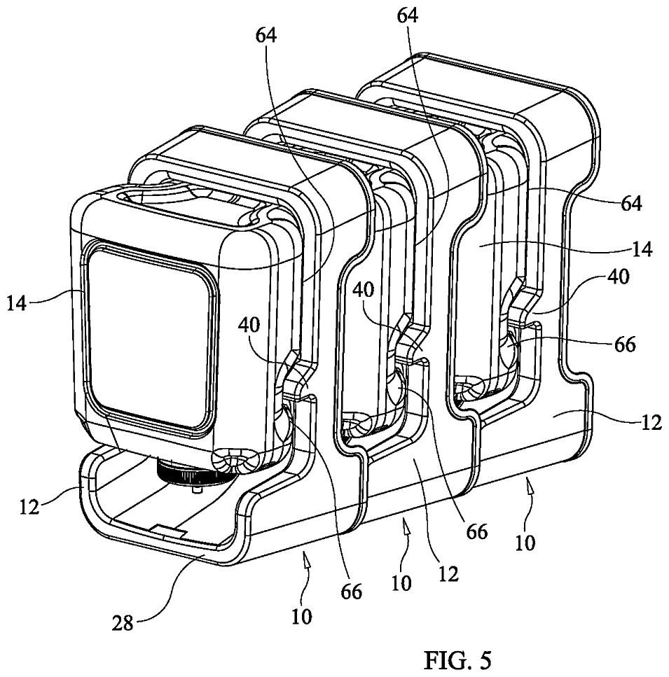

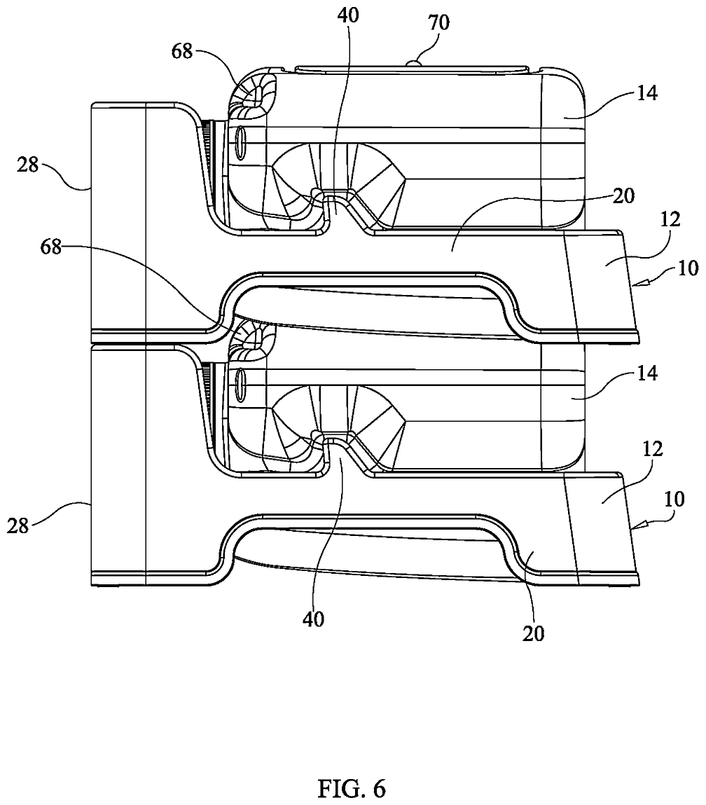

Further, as shown in FIGS. 5 and 6, multiple ones of the dispenser assembly 10 in the stowed orientation can easily be stacked or fitted side-by-side reducing the shelf space required to store an inventory of the dispenser assemblies 10.

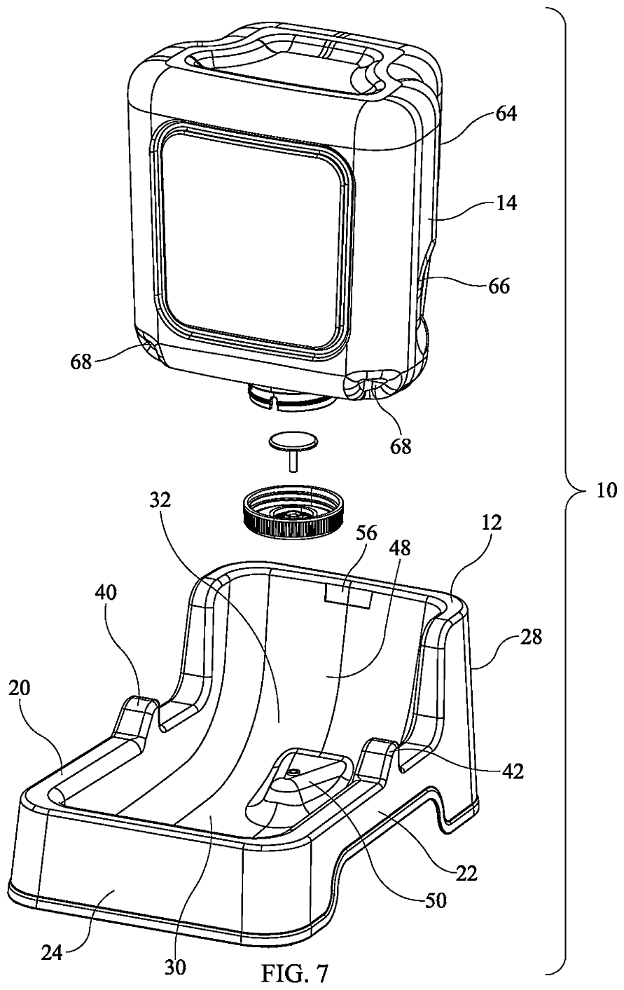

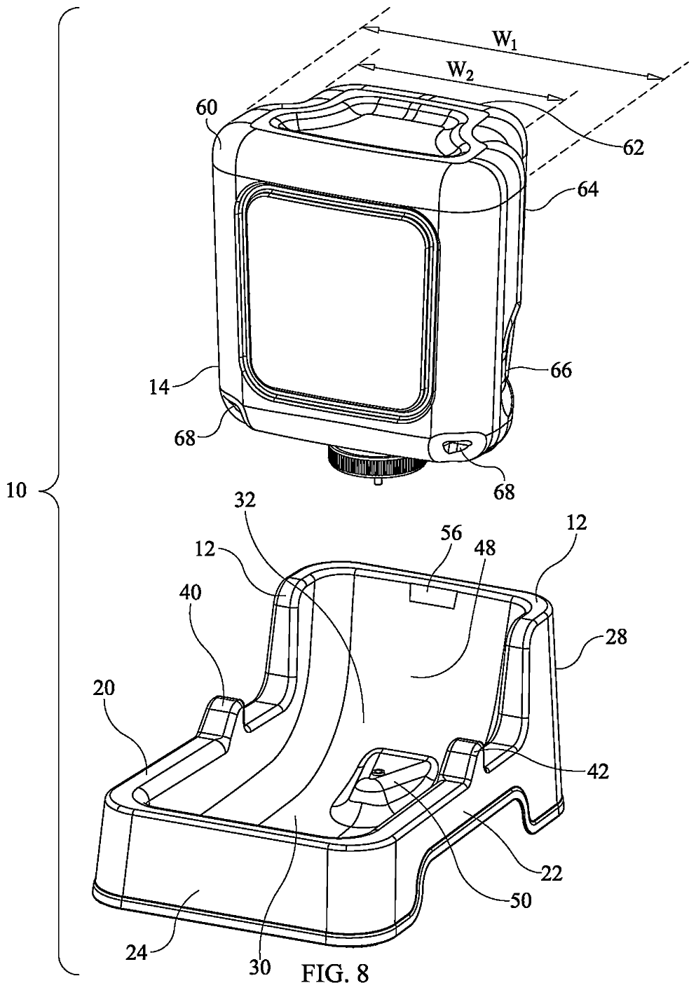

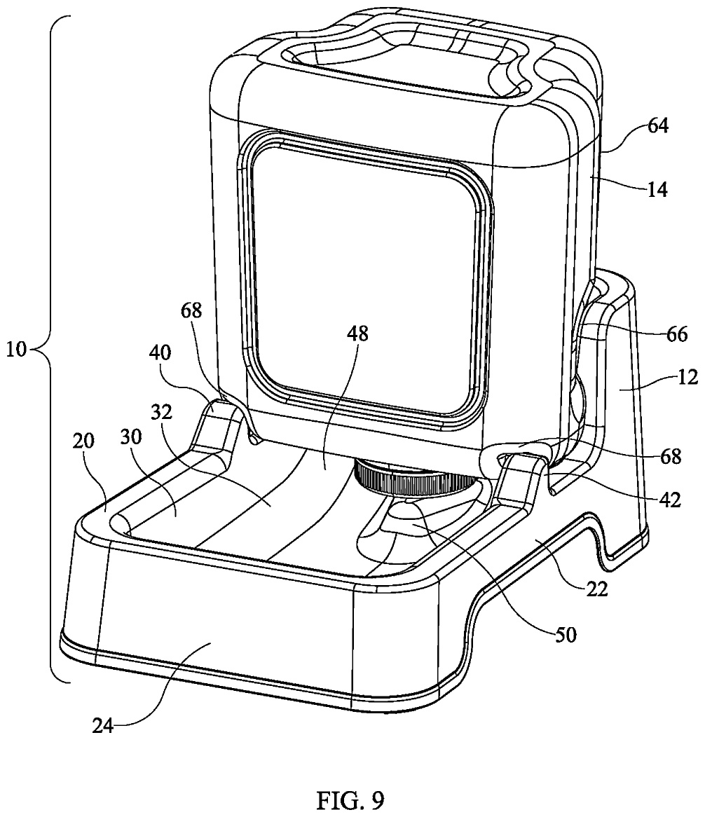

A description of first the base 12 and second the receptacle 14 is now provided with specific reference to FIGS. 7-12.

The base member 12 includes a first wall 20, a second wall 22, a front wall 24, a bottom wall 26 and a back wall 28. A bowl 30 is defined between the first wall 20 and second wall 22 and is further defined by the front wall 24. The bowl 30 is basically an open area where water from the receptacle 14 is retained for consumption by a pet. A receiving area 32 is defined between the first wall 20 and second wall 22 and is further defined by the back wall 28. As shown in FIGS. 7, 8 and 12, the receiving area 32 is open to the bowl 28.

The bowl 30 and the receiving area 32 are open to one another between the first wall 20 and the second wall 22 such that the contents of the receptacle 14 can freely move (due to gravity) from the receptacle 14 into the receiving area 32 and then into the bowl 30. The base member 12 further includes a bottom wall 34 that extends under both the bowl 30 and the receiving area 32.

The first and second walls 20 and 22 have an L-shape as viewed from the side in, for example, FIGS. 3-4, 6 and 11-12. With the dispenser assembly 10 in the in-use orientation, as shown in FIGS. 2-3 and 12, that portion of the first and second walls 20 and 22 that extends along the bowl 30 and the front wall 24 have the same height. The front wall 24 extends between the first and second walls 20 and 22 and surrounds three sides of the bowl 30.

As shown in FIGS. 1-12, the first wall 20 includes a first protrusion 40 and the second wall 22 includes a second protrusion 42. Both the first and second protrusions 40 and 42 extend upward (with the dispenser assembly 10 in the in-use orientation) and away from the first and second walls 20 and 22, and upward and away from the bowl 30 and the receiving area 32. The first and second protrusions 40 and 42 are preferably aligned with each other and parallel to each other, as viewed from the side as shown in FIGS. 3-4, 6 and 11-12. More specifically, both the first and second protrusions 40 and 42 are located along the top of respective ones of the first and second walls 20 and spaced apart from the front wall 24 by identical distances.

The back wall 28 is perpendicular to the top and bottom edges of the first and second walls 20 and 22. Consequently, in the stowed orientation depicted in FIG. 5, and with the back wall 28 on a level surface, the first and second walls 20 and 22 are vertically oriented being 90 degrees (perpendicular) relative to the level surface below the base member and perpendicular to the back wall 28.

The receiving area 32 of the base member has a curved surface 48 that is shaped to direct contents of the receptacle toward and into the bowl. The curved surface 48 extends from the back wall 28 curving along the back wall 28 towards and to a rear portion of the bowl 30. The receiving area 32 of the base member 12 and has a projection that defines a flat surface portion 50. The projection extends upward and away from a lower section of the curved surface 48 with the base member 12 in the in-use orientation. Consequently, the flat surface portion 50 is spaced apart from and above the bottom of the bowl 30 (the bottom wall 26).

As shown in FIGS. 7, 8 and 12, an upper end of the back wall 26 includes a recessed or concaved area 56. Put another way, the concaved area 56 is located at an upper end of the receiving area 32 of the base member 12 adjacent to an upper surface 26a of the back wall 26.

The receptacle 14 is now provided with specific reference to FIGS. 2-4 and 7-12. In the depicted embodiment, the receptacle 14 is basically a bottle having a first section 60 and a second section 62. As shown in FIGS. 2, 3, and 12, the first section 60 has a first width W₁ and the second section has a second width W₂ with the first width W₁ being wider (larger) than the second width W₂. The second width W₂ of the second section 62 is dimensioned such that with the dispenser assembly 10 in the stowed orientation, the second section 62 fits into the bowl 32 and the receiving area 32, as shown in FIGS. 1, 4-6 and 11. Hence, in the stowed orientation, the dispenser assembly 10 has a smaller overall volume than the dispenser assembly 10 has in the in-use orientation. Further, in the stowed orientation, the receptacle 14 at least partially covers both the bowl 30 and the receiving area 34.

The receptacle 14 defines shoulders 64 on opposite sides of the receptacle 14. The shoulders 64 are basically offset surfaces defined at the intersections of the sides of the first section 60 and the second section 62. The shoulders 64 define recesses 66 that are dimensioned and positioned to receive the first and second protrusions 40 and 42 of the base member 12 with the dispenser assembly 10 in the stowed orientation, as shown in FIGS. 1, 4-6 and 11.

Lower front corners of the receptacle 14 (relative to the receptacle 14 being in the in-use orientation) are provided with depressions 68. With the dispenser assembly 10 in the in-use orientation, the depressions 68 are dimensioned and located to receive the first and second protrusions 40 and 42, as shown in FIGS. 2-3, 9 and 12.

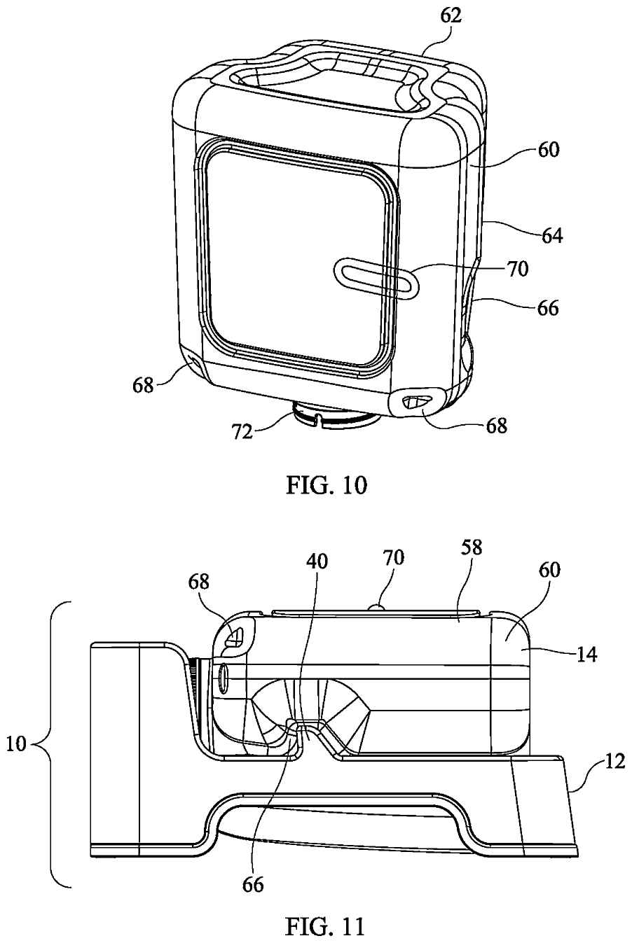

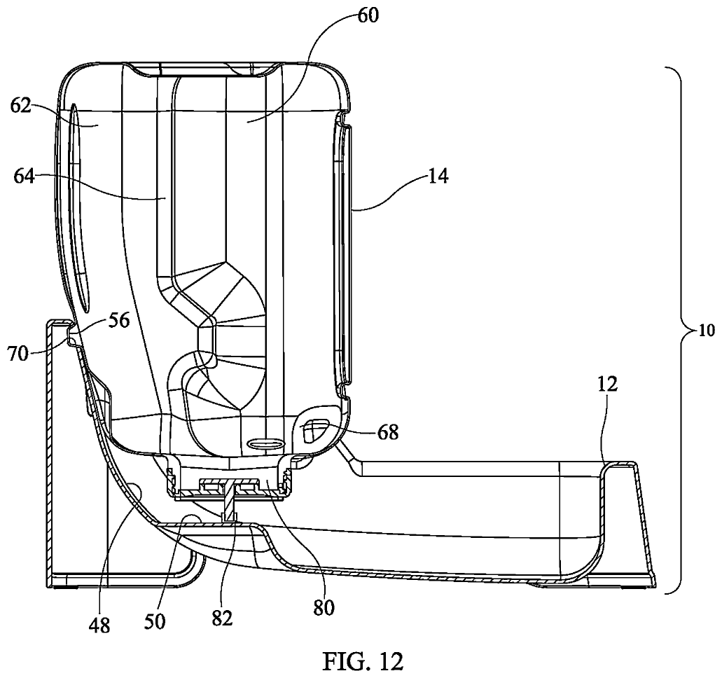

As shown in FIGS. 10 and 12, a rear surface of the receptacle 14 (relative to the receptacle 14 being in the in-use orientation) includes a protrusion 70. As shown in FIG. 12, with the receptacle 14 in the in-use orientation, the protrusion 70, the protrusion 70 extends into the concaved area 56 in the back wall 28 of the base member 12. Engagement between the protrusion 70 and the concaved area 56 serves to align the receptacle 14 relative to the base member 12 and maintain the receptacle 14 in the in-use orientation within the base member 12.

The bottom of the receptacle 14 includes an opening that includes a threaded collar 72 surrounding the opening. A lid 80 is configured to threadedly attach to the collar 72 thereby sealing the receptacle 14. The lid 80 includes a spring biased valve 82. The valve 82 is biased by the spring to a closed orientation, preventing liquid within the receptacle 14 from exiting the receptacle 14. When the bottom of the receptacle 14 is placed into the receiving area 32 of the base 12 in the in-use orientation, a tip of the valve 82 contacts the flat surface portion 50 within the receiving area 32 pushing the valve 82 upward, opening the valve 80 and allowing liquid within the receptacle 14 to flow downward to the receiving area 32 and into the bowl 30. The threaded collar 72 and the lid 80 are positioned such that in the in-use orientation, they are both below an upper edge of the bowl 30. Therefore, once the level of liquid (for instance, water) in the bowl 30 is higher than the valve 82, suction within the receptacle 14 prevents further liquid from flowing out of the receptacle 14.

In the first embodiment and in the embodiments described below, the receptacles are all preferably made of a transparent material, such as a polymer or plastic material so that a pet owner can see the amount of water or food within the receptacle.

The receptacle can also be referred to a bottle or container.

### SECOND EMBODIMENT

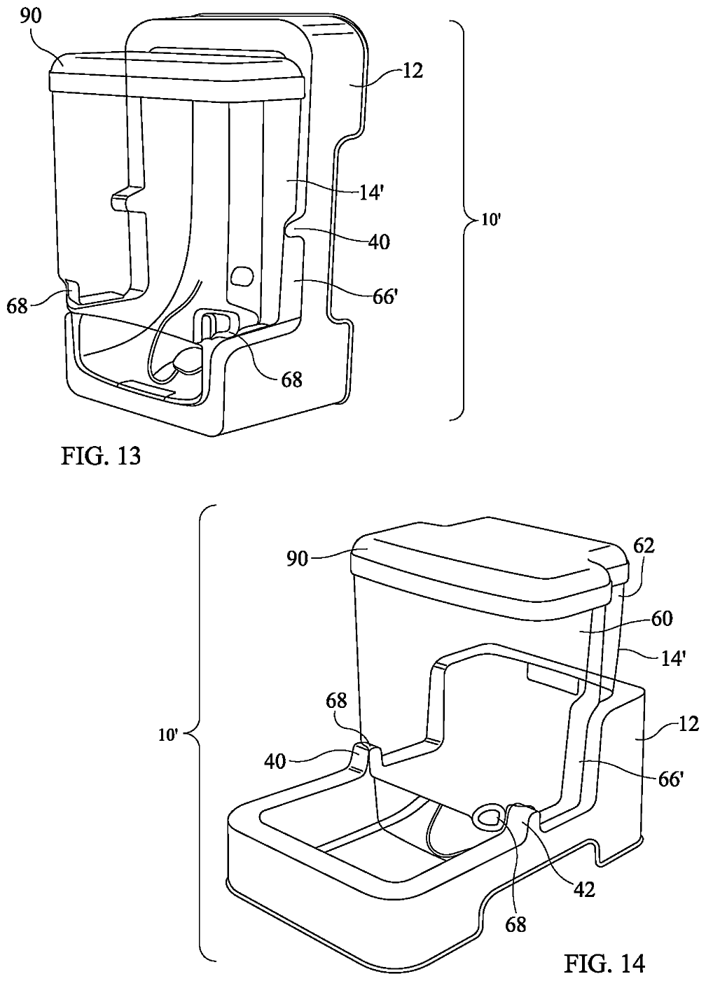

Referring now to FIGS. 13-17, a dispenser assembly 10′ in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity. The parts of the second embodiment that differ from the parts of the first embodiment will be indicated with a single prime (′).

The dispenser assembly 10′ includes the base member 12 and a receptacle 14′.

The base member 12 is identical to the base member 12 of the first embodiment and includes all of the features described above with respect to the first embodiment.

The receptacle 14′ has many of the features of the receptacle 14 of the first embodiment but has been modified to dispense solid or semi-solid pet food to the bowl 30 of the base member 12. Specifically, the receptacle 14′ includes the first section 60 and the second section 62 as described above with respect to the first embodiment. However, in the second embodiment, shoulders 64′ have been modified to include elongated recesses 66′, replacing the recesses 66 of the first embodiment. The elongated recesses 66′ are again dimensioned and located to receive the first and second protrusions 40 and 42 of the base member 12, as described above in the first embodiment.

Further, in the second embodiment, the receptacle 14′ includes depressions 68 and the protrusion 70, as described above with respect the receptacle 14 of the first embodiment.

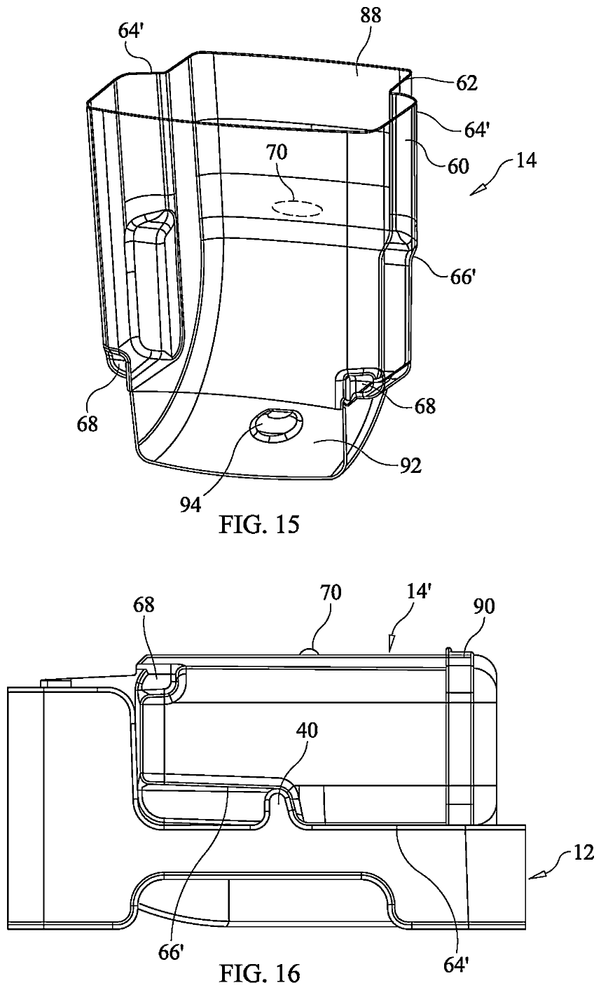

As shown in FIG. 15, the bottom of the receptacle 14′ includes a curved area 92 (also referred to as a chute 92) such that the solid food, or semi-solid food within the receptacle 14′ can flow from the interior of the receptacle 14′ through the chute 92 and into the bowl 30.

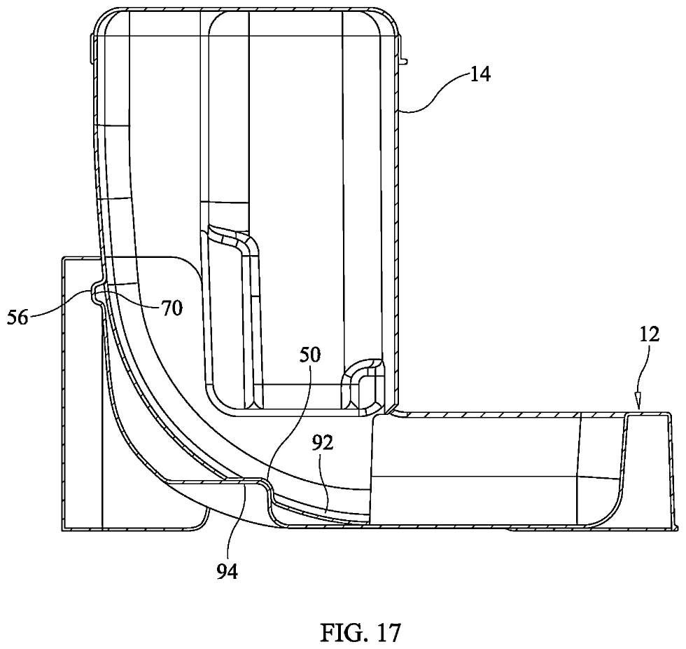

The curved area 92 (or chute 92) includes a concaved area 94 (concaved relative to a lower outer surface of the receptacle 14′. The concaved area 94 defines a convex area within a central area of the chute 92. The concaved area 94 is dimensioned and located such that the flat surface portion 50 extends into a central area of the chute 92 thereby stabilizing and retaining the receptacle 14′ within the receiving area 32 of the base member 12 in the in-use orientation, as shown in FIG. 17.

The top of the receptacle 14′ has an open end 88 and is dimensioned and shaped to receive a lid or cover 90. The base 12 includes the concaved area 56 (recessed area) as described above with respect to the first embodiment. Similarly, the receptacle 14′ includes the protrusion 70 also described above with respect to the first embodiment.

### THIRD EMBODIMENT

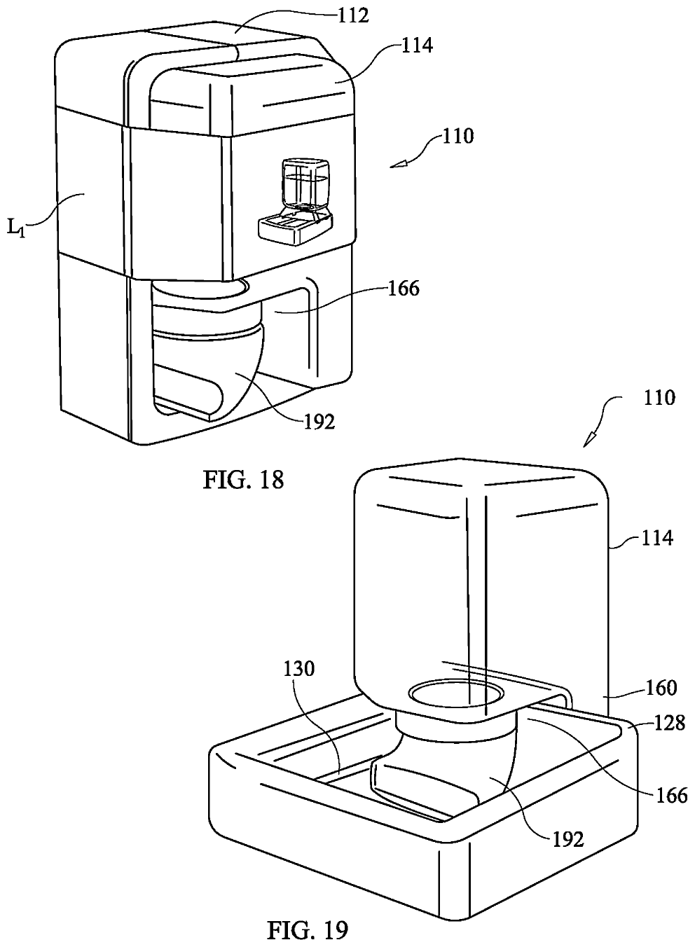

Referring now to FIGS. 18-20, a dispenser assembly 110 in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

As shown in FIG. 18, the dispenser assembly 110 includes a base member 112 and a receptacle 114 in a stowed orientation with at least a portion of the receptacle 114 being inserted into a bowl 130 of the base member 112. A marketing label Li is wrapped around the receptacle 114 and base member 112 holding them together as the dispenser assembly 110 might be shown in a store on a shelf.

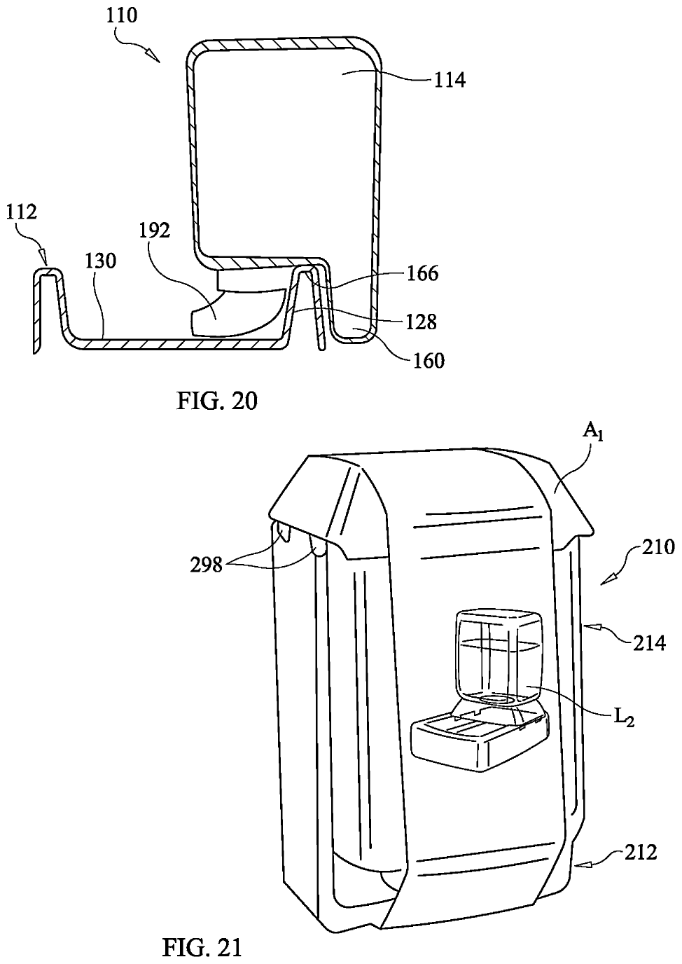

As shown in FIG. 19, the receptacle 114 of the dispenser assembly 110 can be positioned on a rear wall 128 of the base member 112 in an in-use orientation. The receptacle 114 includes an inverted U-shaped recess 166 that fits over the rear wall 128 in the in-use orientation. The inverted U-shaped recess 166 defined between a chute 192 of the receptacle 114 and a rear lower area 160 of the receptacle 114, as shown in FIG. 20.

### FOURTH EMBODIMENT

Referring now to FIGS. 21-23, a dispenser assembly 210 in accordance with a fourth embodiment will now be explained. In view of the similarity between the first and fourth embodiments, the parts of the fourth embodiment that are identical to the parts of the first embodiment will be given the same reference numerals as the parts of the first embodiment. Moreover, the descriptions of the parts of the fourth embodiment that are identical to the parts of the first embodiment may be omitted for the sake of brevity.

As shown in FIG. 21, the dispenser assembly 210 has a base member 212, a retaining member A₁ and a receptacle 214 shown in a stowed orientation with at least a portion of the receptacle 214 inserted into a bowl 230 of the base member 212. A marketing label L₂ wrapped around the receptacle 214, the retaining member A₁ and the base member 212 holding them together. The depiction in FIG. 21 corresponds to the appearance of the dispenser assembly 210 when on a store shelf being offered for sale.

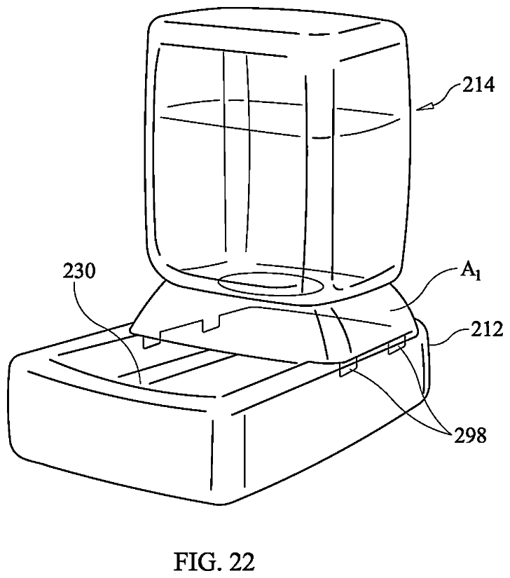

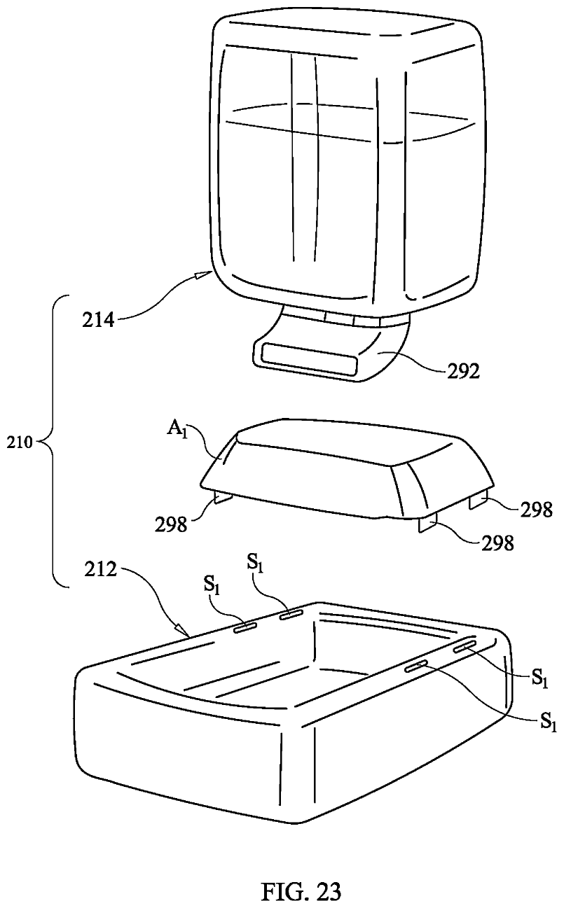

In the in-use orientation shown in FIGS. 22 and 23, the retaining member A₁ has projections 298 that fit into corresponding slots S₁ of the base member 212 of the dispenser assembly 210. The receptacle 214 is set on top of the retaining member A₁ in the in-use orientation such that a chute 292 of the receptacle 214 extends through an opening in the retaining member A₁ and further into the bowl 230 of the base member 212.

### FIFTH EMBODIMENT

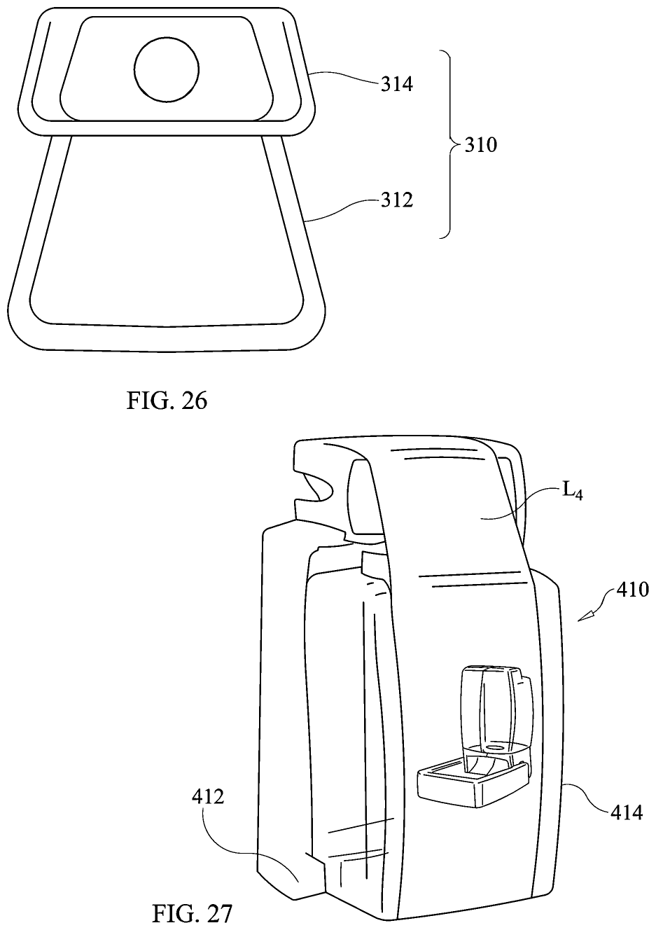

Referring now to FIGS. 24-26, a dispenser assembly 310 in accordance with a fifth embodiment will now be explained. In view of the similarity between the first and fifth embodiments, the parts of the fifth embodiment that are identical to the parts of the first embodiment will be given the same reference numerals as the parts of the first embodiment. Moreover, the descriptions of the parts of the fifth embodiment that are identical to the parts of the first embodiment may be omitted for the sake of brevity.

In FIG. 24, a base member 312, a retainer member A₂ and a receptacle 314 of the dispenser assembly 310 are shown in a stowed orientation with at least a portion of the receptacle 314 being inserted into a bowl of the base member 312 with a marketing label L₃ wrapped around the receptacle 314, the retainer member A₂ and base member 312 holding them together. The depiction in FIG. 24 corresponds to the appearance of the dispenser assembly 210 when on a store shelf being offered for sale.

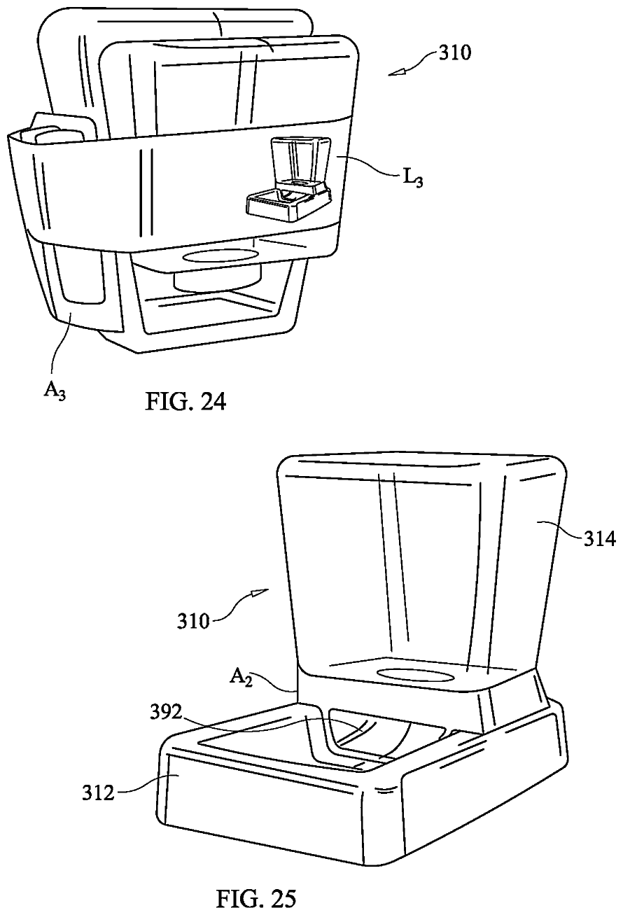

In the in-use orientation shown in FIG. 25, the retaining member A₂ has projections (not shown) that fit into corresponding slots (not shown) of the base member 312 of the dispenser assembly 310. The receptacle 314 is set on top of the retaining member A₂ in the in-use orientation such that a chute 392 of the receptacle 214 extends through an opening in the retaining member A₂ and further into the bowl of the base member 312.

### SIXTH EMBODIMENT

Referring now to FIGS. 27-29, a dispenser assembly 410 in accordance with a sixth embodiment will now be explained. In view of the similarity between the first and sixth embodiments, the parts of the sixth embodiment that are identical to the parts of the first embodiment will be given the same reference numerals as the parts of the first embodiment. Moreover, the descriptions of the parts of the sixth embodiment that are identical to the parts of the first embodiment may be omitted for the sake of brevity.

The dispenser assembly 410 includes a base member 412, a retaining member A₃ and a receptacle 414. In FIG. 27 the dispenser assembly 410 is shown in a stowed orientation with at least a portion of the receptacle 414 being inserted into a bowl of the base member 412 with a marketing label L₄ wrapped around the receptacle 414, the retaining member A₃ and the base member 412 holding them together. The depiction in FIG. 27 corresponds to the appearance of the dispenser assembly 410 when on a store shelf being offered for sale.

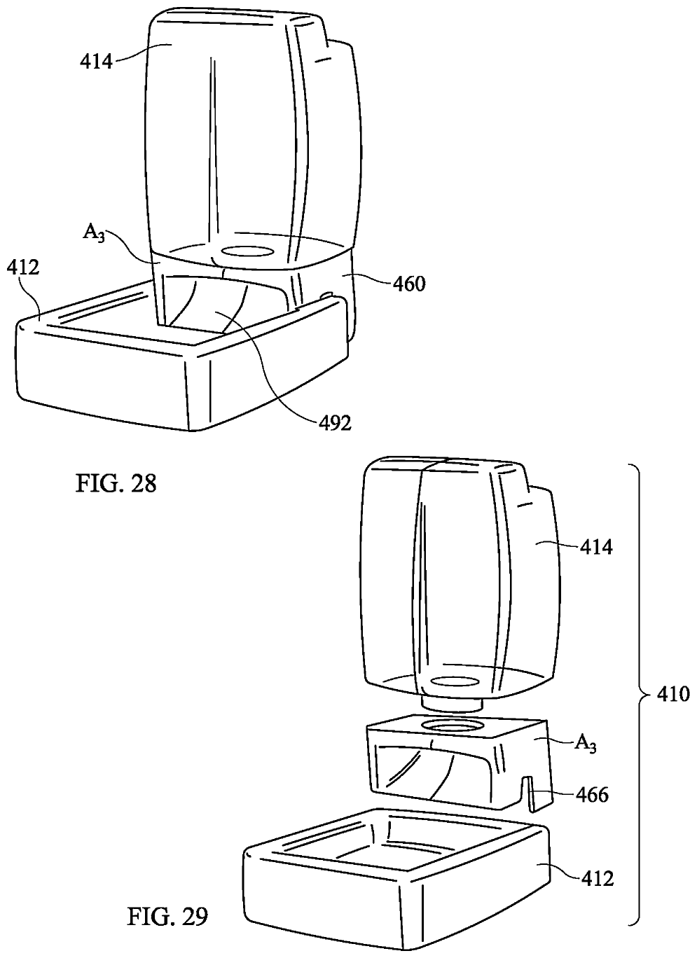

In FIGS. 28 and 29, the retaining member A₃ is shown fitted to the base member 412 such that a slot 466 in the retaining member A₃ fits over a rear wall of the base member 412. The retaining member A₃ includes a chute that slopes down to the bowl of the base member 412. The retaining member A₃ has an opening that receives a collar at the bottom of the receptacle 414 such that the contents of the receptacle 412 is directed into the bowl of the base member 412.

### SEVENTH EMBODIMENT

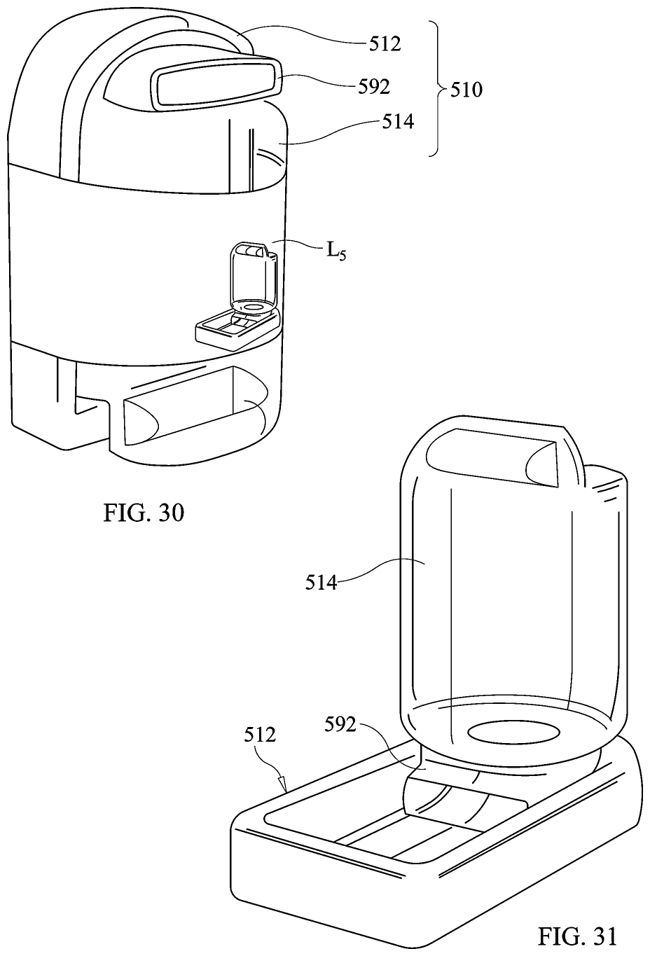

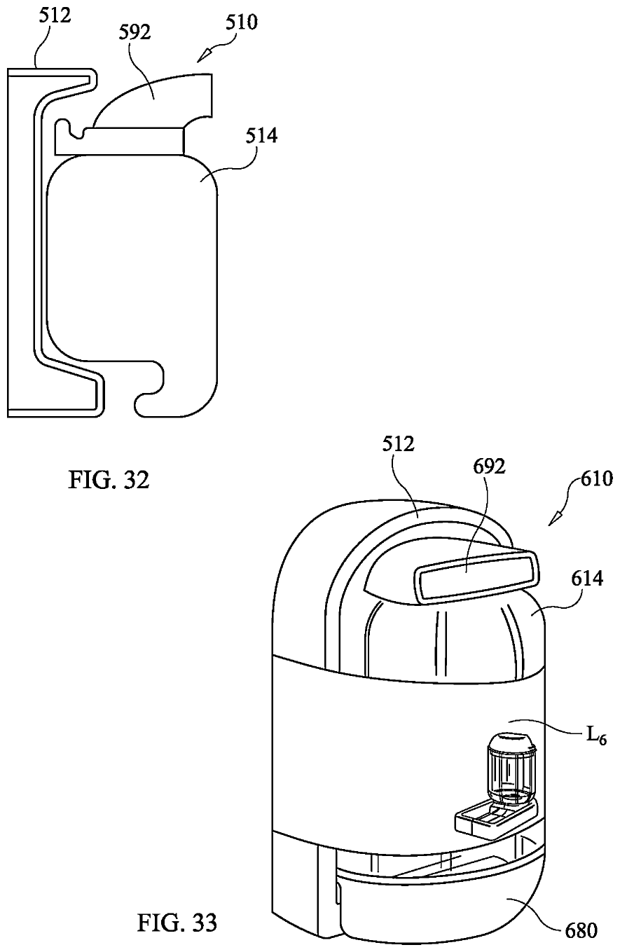

Referring now to FIGS. 30-32 a dispensing assembly 510 in accordance with a seventh embodiment will now be explained. In view of the similarity between the first and seventh embodiments, the parts of the seventh embodiment that are identical to the parts of the first embodiment will be given the same reference numerals as the parts of the first embodiment. Moreover, the descriptions of the parts of the seventh embodiment that are identical to the parts of the first embodiment may be omitted for the sake of brevity.

The dispensing assembly 510 includes a base member 512 and a receptacle 514. The receptacle 514 includes a handle shaped recess at one end and a chute 592 at the other end.

In FIG. 33 the dispenser assembly 510 is shown in a stowed orientation with at least a portion of the receptacle 514 being inserted into a bowl of the base member 512 with a marketing label L₅ wrapped around the receptacle 514 and the base member 512 holding them together. The depiction in FIG. 30 corresponds to the appearance of the dispenser assembly 510 when on a store shelf being offered for sale.

FIG. 34 shows the receptacle 814, the chute 692 and the lid 680 separated from one another.

### EIGHTH EMBODIMENT

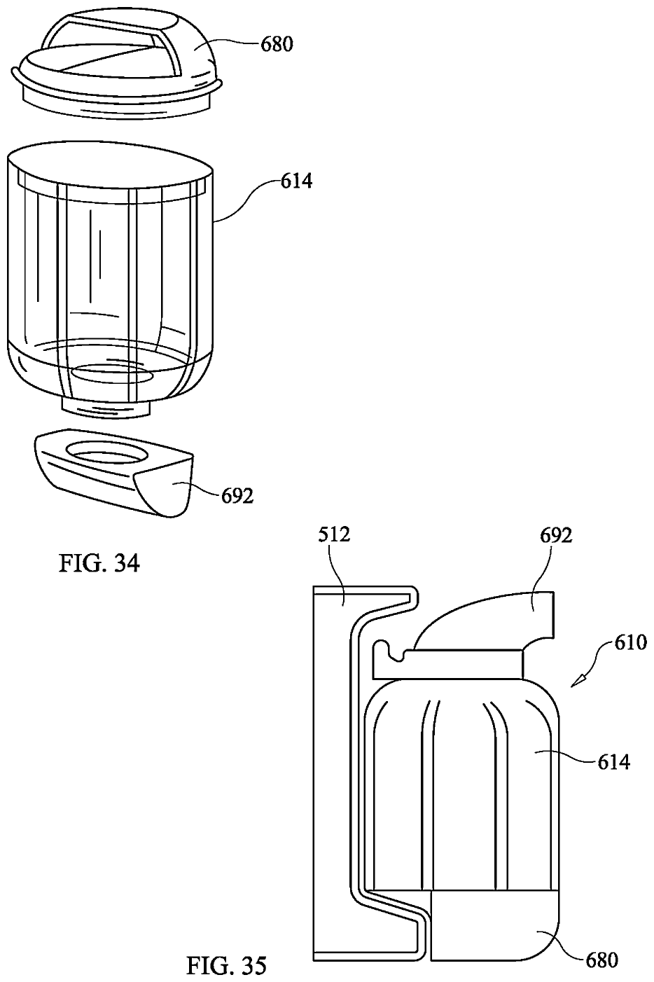

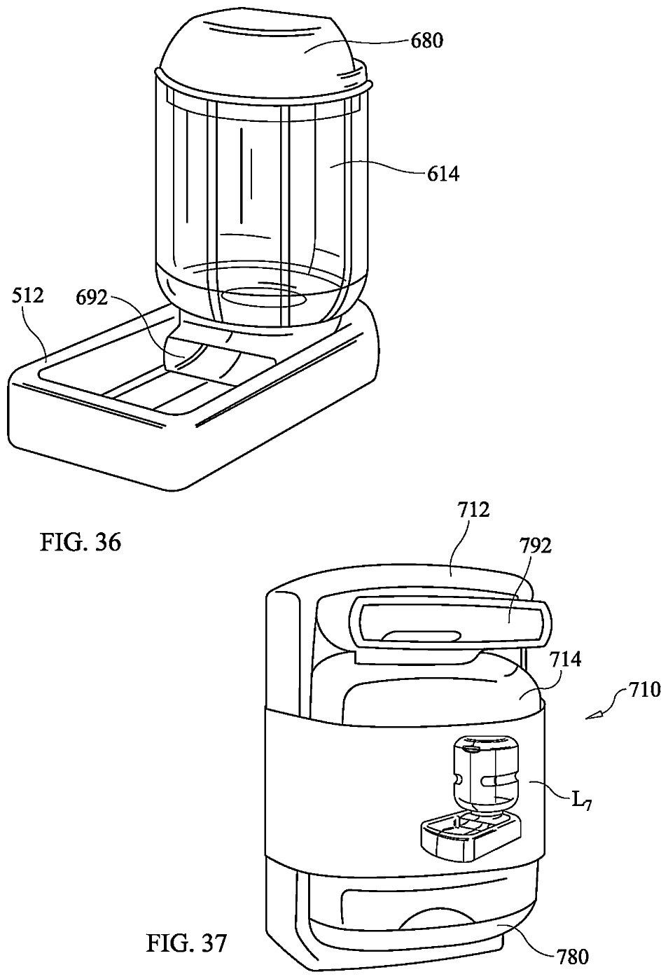

Referring now to FIGS. 33-36, a dispensing assembly 610 in accordance with an eighth embodiment will now be explained. In view of the similarity between the first and eighth embodiments, the parts of the eighth embodiment that are identical to the parts of the first embodiment will be given the same reference numerals as the parts of the first embodiment. Moreover, the descriptions of the parts of the eighth embodiment that are identical to the parts of the first embodiment may be omitted for the sake of brevity.

The dispenser assembly 610 includes a base member 512 (identical to the base member of the seventh embodiment) and a receptacle 614. FIG. 33 shows the dispenser assembly 610 in a stowed orientation with at least a portion of the receptacle 614 being inserted into a bowl of the base member 512 with a marketing label L₆ wrapped around the receptacle 614 and base member 512 holding them together. The depiction in FIG. 33 corresponds to the appearance of the dispenser assembly 610 when on a store shelf being offered for sale.

The receptacle 614 includes a removable chute 692 and a removable lid 680. FIG. 34 shows the receptacle 614, the chute 692 and the lid 680 separated from one another.

### NINTH EMBODIMENT

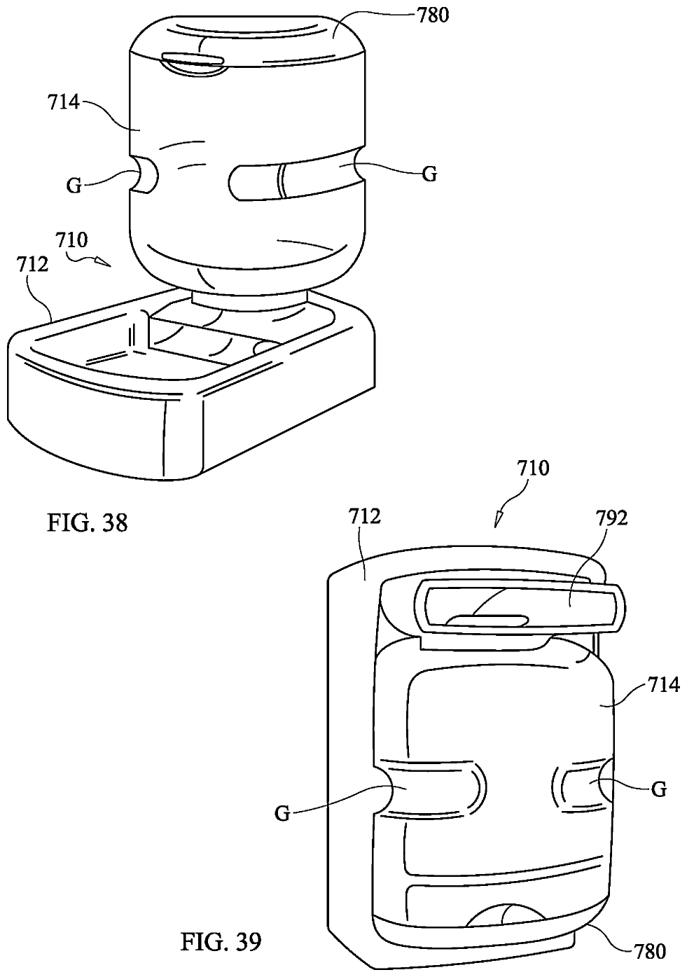

Referring now to FIGS. 37-39, a dispenser assembly 710 in accordance with a ninth embodiment will now be explained. In view of the similarity between the first and ninth embodiments, the parts of the ninth embodiment that are identical to the parts of the first embodiment will be given the same reference numerals as the parts of the first embodiment. Moreover, the descriptions of the parts of the ninth embodiment that are identical to the parts of the first embodiment may be omitted for the sake of brevity.

The dispenser assembly 710 includes a base member 712, a receptacle 714 and a removable cover or lid 780. As shown in FIG. 37 in a stowed orientation, at least a portion of the receptacle 714 is inserted into a bowl of the base member 712 with a marketing label L₇ wrapped around the receptacle 714 and base member 712 holding them together. The receptacle 714 includes a pair of recesses that define grips G, and a removable chute 792.

### TENTH EMBODIMENT

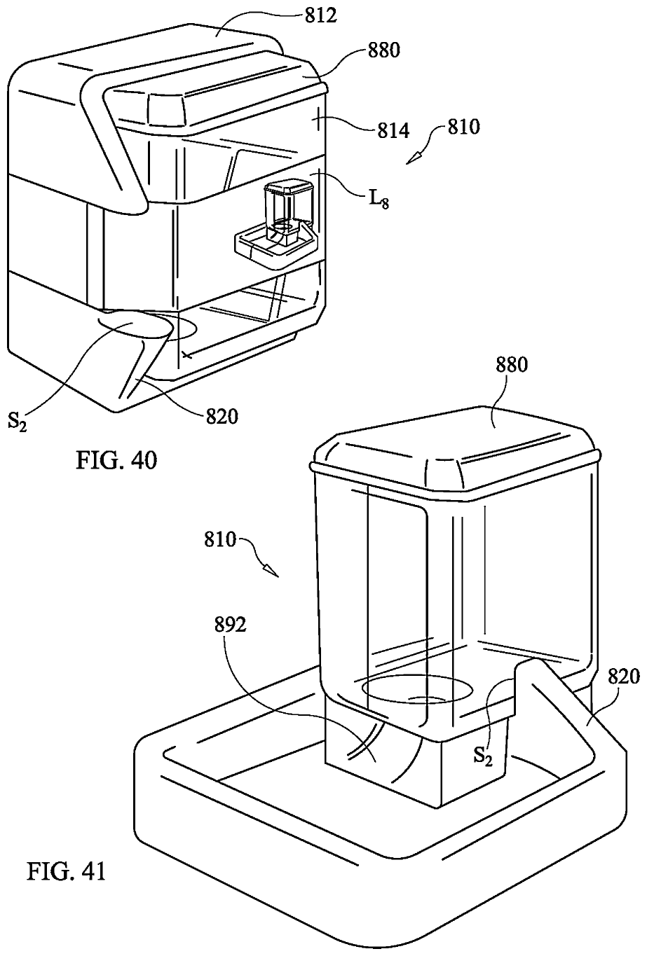

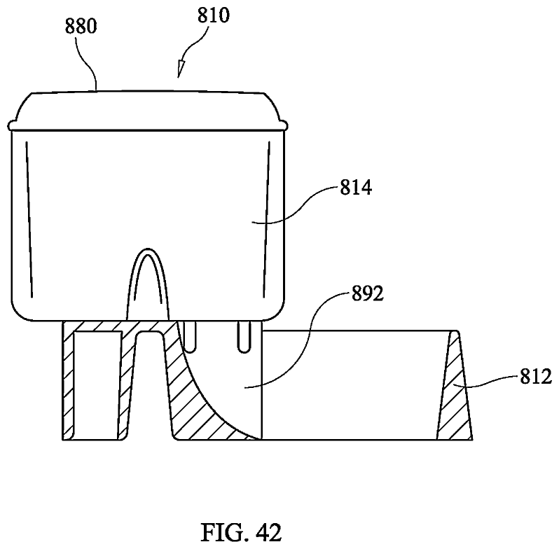

Referring now to FIGS. 40-42, a dispenser assembly 810 in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The dispenser assembly 810 includes a base member 812, a receptacle 814, a lid 880 and a removable chute 892. As shown in FIG. 40 in a stowed orientation, at least a portion of the receptacle 814 is inserted into a bowl of the base member 812 with a marketing label L₈ wrapped around the receptacle 814 and base member 812 holding them together. The receptacle 814 includes the removable lid 880 and the removable chute 892.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiments, the following directional terms “forward”, “rearward”, “above”, “downward”, “vertical”, “horizontal”, “below” and “transverse” as well as any other similar directional terms refer to those directions of a vehicle equipped with the dispenser assembly. Accordingly, these terms, as utilized to describe the present invention should be interpreted relative to a vehicle equipped with the dispenser assembly.

The terms of degree such as “substantially”, “about” and “approximately” as used herein mean a reasonable amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such features. Thus, the foregoing descriptions of the embodiments according to the present invention are provided for illustration only, and not for the purpose of limiting the invention as defined by the appended claims and their equivalents.

What is claimed is:

1. A dispenser assembly comprising:
a base member having a bowl; and
a receptacle having a dispensing opening defined at the first end thereof, the receptacle being configured to fit on to the base member such that the dispensing opening is positioned to dispense contents of the receptacle into the bowl of the base member in an in-use orientation, and
the receptacle being configured to at least partially fit into the bowl in a stowed orientation such that in the stowed orientation the receptacle and base member define a volume that is less than a volume corresponding to the in-use orientation.

2. The dispenser assembly according to claim 1, wherein
the base member includes a first wall and a second wall with the bowl being defined therebetween, the first wall having a first protrusion and the second wall having a second protrusion, both first and second protrusions extending away from the first and second walls and the bowl, and
the receptacle has a first side, a second side, a first end and a second end, with the dispensing opening defined at the first end thereof, the first side having a first recess and the second side having a second recess such that in the stowed orientation the first and second protrusions extend into the first and second recesses, respectively.

3. A dispenser assembly comprising:
a base member having a first wall and a second wall with a bowl and a receiving area open to the bowl that are both defined between the first wall and the second wall, the first wall having a first protrusion and the second wall having a second protrusion, both first and second protrusions extending away from the first and second walls, the bowl and the receiving area; and
a receptacle having a first side, a second side, a first end and a second end, with a dispensing opening defined at the first end thereof, the first side having a first recess and the second side having a second recess, and
the receptacle being configured to fit into both the bowl and the receiving area with the first support protrusion extending into the first recess and the second support protrusion extending into the second recess in a stowed orientation.

4. The dispenser assembly according to claim 3, wherein
in the stowed orientation, the receptacle at least partially covers the bowl and the receiving area.

5. The dispenser assembly according to claim 3, wherein
the receptacle is further dimensioned and shaped such that the first end fits into the receiving area in an in-use orientation with the bowl being exposed, the first protrusion extending into a third recess and the second protrusion extending into the fourth recess, the third and fourth recesses being formed at opposite corners of the receptacle along an edge of the first end adjacent to the bowl.

6. The dispenser assembly according to claim 5, wherein
the receiving area of the base member has a back wall that extends between the first wall and the second wall, and the receptacle has a back side that extends between the first side and the second side of the receptacle, and
one of the back wall of the base member and the back side of the receptacle includes a protrusion and the other of the back wall and the back side includes a concaved area such that with the receptacle in the in-use orientation the protrusion extends into the concaved area aligning the receptacle with the receiving area of the base.

7. The dispenser assembly according to claim 5, wherein
with the receptacle in the in-use orientation, the base and the receptacle together fit into a rectangular box for shipping having a first volume, and
with the receptacle in the stowed orientation, the base and the receptacle together fit into a second rectangular box for shipping having a second volume that is less than the first volume.

8. The dispenser assembly according to claim 7, wherein
the second volume is between 70 and 80% less than the first volume.

9. The dispenser assembly according to claim 3, wherein
the receiving area of the base member has a curved surface that is shaped to direct contents of the receptacle toward and into the bowl.

10. The dispenser assembly according to claim 9, wherein
the receiving area of the base member has a flat surface portion that extends upward and away from the curved surface with the base in an in-use orientation.

11. The dispenser assembly according to claim 10, wherein
the receptacle includes an opening defined at the first end thereof and further includes a lid with a valve that is spring biased to a closed position and with the receptacle positioned within the receiving area in the in-use orientation, the valve contacts the flat surface portion thereby opening the valve.

12. The dispenser assembly according to claim 11, wherein
the receptacle is configured to dispense water into the receiving area and the bowl of the base with the receptacle in the in-use orientation and the valve opened.

13. The dispenser assembly according to claim 12, wherein
the receptacle is a sealed container with the lid installed to opening in the first end of the receptacle and the valve being in the closed position.

14. The dispenser assembly according to claim 10, wherein
the receptacle includes a curved surface having a concaved area defined relative to an outer surface of the receptacle, the concaved area being shaped, dimensioned and located to receive the flat surface portion with the first end of the receptacle positioned within the receiving area in the in-use orientation.

15. The dispenser assembly according to claim 14, wherein
the receptacle is configured to dispense pet food into the receiving area and the bowl of the base with the receptacle in the in-use orientation.
